(19) United States
(12) Patent Application Publication
(10) Pub. No.: US 2007/0104189 A1
(43) Pub. Date: May 10, 2007

(54) NETWORK SYSTEM AND OPERATION METHOD THEREOF

(75) Inventors: CHUAN-CHENG HSU, Tu-Cheng,Taipei Hsien (TW); KAI-YING KO, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,539

(22) Filed: Aug. 18, 2006

(30) Foreign Application Priority Data
Nov. 10, 2005 (CN) 200510101207.9

(51) Int. Cl. H04L 12/56

(52) U.S. Cl. 370/389

(57) ABSTRACT

A network system includes a client device (10), a central office (50), and a network device (30) connected to the client and the central office. The network device includes a first control card (300), a second control card (400), and a plurality of line cards (100) connected to the first control card, the second control card, and the client. Connections between the first control card and one part of the line cards are designated as primary connections, and connections between the second control card and the same part of the line cards are designated as redundant connections. Meanwhile, connections between the second control card and a remaining part of the line cards are designated as primary connections, and connections between the first control card and the remaining part of the line cards are designated as redundant connections.

### FIELD OF THE INVENTION

The invention relates to network systems, and particularly to a network system and an operation method thereof.

### DESCRIPTION OF THE RELATED ART

With the rapid development of network systems, network devices, such as routers, switches etc. often have a spare/backup function to ensure operating stability of the network devices. Conventionally, the network device comprises a primary control card for processing and exporting data packets via some uplink ports of the network device, and a secondary control card used as a spare/backup one for processing and exporting the data packets. The secondary control card processes and exports the data packets via other uplink ports of the network device only if the primary control card has malfunctioned. That is, only one part of the uplink ports of the network device can export data packets. Therefore, transmission of the data packets is slow.

Therefore, a heretofore unaddressed need exists in the industry to overcome the aforementioned deficiencies and inadequacies.

### SUMMARY OF THE INVENTION

An exemplary embodiment of the invention provides a network system. The network system includes a client device, a central office, and a network device connected to the client device and the central office. The network device includes a first control card, a second control card, and a plurality of line cards connected to the first control card, the second control card, and the client device. Connections between the first control card and one part of the line cards are designated as primary connections, and connections between the second control card and the same part of the line cards are designated as redundant connections. Meanwhile, connections between the second control card and a remaining part of the line cards are designated as primary connections, and connections between the first control card and the remaining part of the line cards are designated as redundant connections.

Another exemplary embodiment of the invention provides an operation method of a network system. The operation method includes steps of: providing a first control card, a second control card, a backplane, and a plurality of line cards; establishing connections between the line cards and the first control card and the second control card; designating primary connections between the first control card and one part of the line cards, and redundant connections between the second control card and the same part of the line cards; designating primary connections between the second control card and a remaining part of the line cards, and redundant connections between the first control card and the remaining part of the line cards; and starting the primary connections.

Other advantages and novel features will become more apparent from the following detailed description when taken in conjunction with the accompanying drawings, in which:

### BRIEF DESCRIPTION OF THE DRAWINGS

FIG. 1 is a schematic view of a network system of an exemplary embodiment of the invention;

FIG. 2 is a block diagram of a network device of the network system of FIG. 1; and

FIG. 3 is a flowchart of an operation method of the network of another exemplary embodiment of the invention.

### DETAILED DESCRIPTION OF THE INVENTION

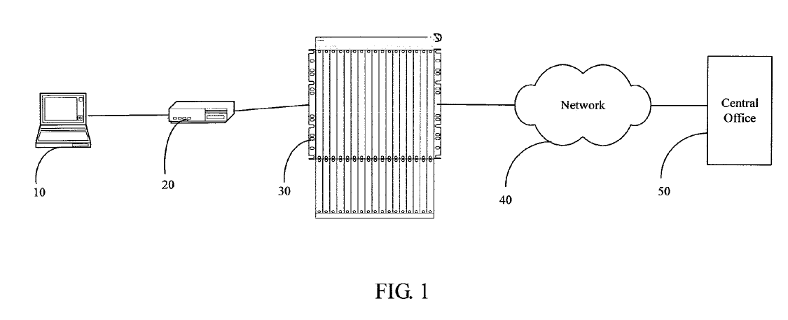

FIG. 1 is an environment of a network system of an exemplary embodiment of the invention. A client device 10 is connected to a network device 30 via an asymmetrical digital subscriber loop transceiver unit-remote terminal (ATU-R) 20. The network device 30 is in communication with a central office 50 via a network 40. The network 40 may comprise any network known in the art, such as the Internet, an Intranet, a Fiber Channel network, Storage Area Network (SAN), Local Area Network (LAN), etc. In the exemplary embodiment, the client device 10 may be a personal computer, a personal digital assistant (PDA), and so on.

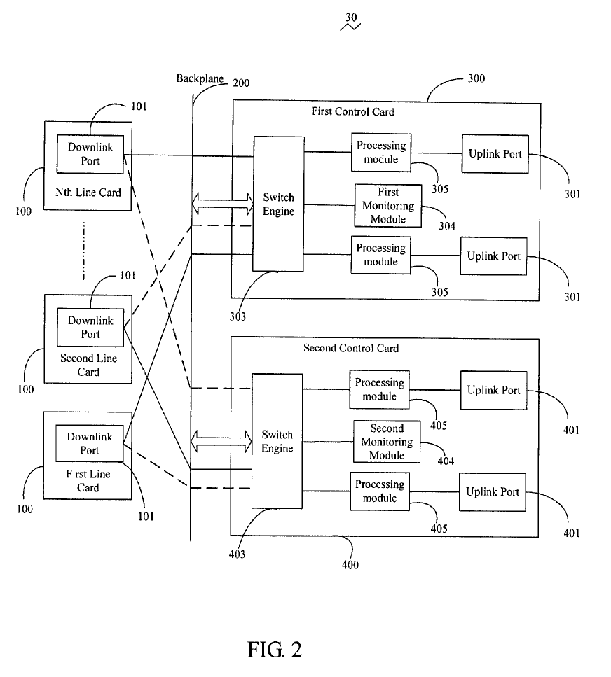

FIG. 2 is a block diagram of the network device 30 of the network system of FIG. 1. In the exemplary embodiment, the network device 30 comprises a plurality of line cards 100, a backplane 200, a first control card 300 and a second control card 400. The backplane 200 connects the line cards 100 to the first control card 300 and the second control card 400, and connects the first control card 300 to the second control card 400. In the exemplary embodiment, the line cards 100 are consecutively labeled as a first line card, a second line card, . . . , and an nth line card.

The line cards 100 are connected to the client device 10 via the ATU-R 20 of FIG. 1, and connected to the first and second control cards 300, 400 via the backplane 200. Each line card 100 comprises a downlink port 101 connected to the backplane 200 and the client device 10. The downlink ports 101 receive data packets from the first control card 300, the second control card 400, and the client device 10, and transmit data packets processed in the line cards 100 to the first control card 300, the second control card 400, and the client device 10. In the exemplary embodiment, the downlink ports 101 of the line cards 100 are connected to the first control card 300 and the second control card 400 via the backplane 200. The connections between odd-numbered line cards 100 and the first control card 300 are designated as primary connections, and the connections between the odd-numbered line cards 100 and the second control card 400 are designated as redundant connections. Meanwhile, the connections between even-numbered line cards 100 and the second control card 400 are designated as a primary connections, and the connections between the even-numbered line cards 100 and the first control card 300 are designated as redundant connections. Note that the primary and redundant connection settings can be reversed or altered by means of other rules.

The first control card 300 and the second control card 400 are connected to the central office 50 via the network 40. The first control card 300 comprises two uplink ports 301, two processing modules 305, and a switch engine 303. The uplink ports 301 receive data packets from the central office 50, and transmit the data packets to the processing modules 305 respectively. The processing modules 305 process the data packets, and transmit the processed data packets to the switch engine 303. The second control card 400 comprises two uplink ports 401, two processing modules 405, and a switch engine 403. The uplink ports 401 receive the data packets from the central office 50, and transmit the data packets to the processing modules 405 respectively. The processing modules 405 process the data packets, and transmit the processed data packets to the switch engine 403. The switch engines 303 and 403 transmit the processed data packets to the corresponding line cards 100 or transmit the processed data packets to each other via the backplane 200.

In alternative embodiments, the first control card 300 can comprise an uplink port 301 or a plurality of uplink ports 301, and a processing module 305 or a plurality of processing modules 305. Meanwhile, the uplink ports 301 can be connected to the processing modules 305 respectively, or the uplink ports 301 are connected to the processing module 305. Correspondingly, the second control card 400 can comprise an uplink port 401 or a plurality of uplink ports 401, and a processing module 405 or a plurality of processing modules 405. Meanwhile, the uplink ports 401 can be connected to the processing modules 405 respectively, or the uplink ports 401 are connected to the processing module 405.

For example, when the uplink ports 301 of the first control card 300 receive the data packets from the central office 50, herein the data packets are designated as a first data packets, the processing modules 305 process the first data packet, and transmit the processed first data packets to the switch engine 303. The switch engine 303 determines destination of the processed first data packets. If the destination is the client device 10, the switch engine 303 transmits the processed first data packets to the line cards 100 via the backplane 200. In the line cards 100, the processed first data packets are further processed, and designated as second data packets. The downlink ports 101 of the line card 100 transmit the second data packets to the client device 10 via the ATU-R 20. If the destination is another central office, the switch engine 303 transmits the processed first data packets to the switch engine 403 of the second control card 400. Then, the processed first data packets are transmitted to the central office via the uplink ports 401 of the second control card 400.

When the line card 100 receives data packets from the client device 10, herein the data packets are designated as third data packets, the third data packets are processed in the line card 100, and the processed third data packets are transmitted to the backplane 200 via the downlink port 101 of the line card 100 according to the primary connection. The backplane 200 transmits the processed third data packets to the switch engine 303 of the first control card 300, and the switch engine 403 of the second control card 400. In the processing modules 305 and 405, the processed third data packets are further processed and designated as fourth data packets. Then, the uplink ports 301 and 401 transmit the fourth data packets to the central office 50.

The first control card 300 further comprises a first monitoring module 304, and the second control card 400 further comprises a second monitoring module 404. The first monitoring module 304 and the second monitoring module 404 send “hello” messages to each other in an advance time period such as 3 seconds, to determine whether one of the first and second control cards 300, 400 has malfunctioned. For example, if the second monitoring module 404 does not receive “hello” message from the first monitoring module 304 over the advance time period, the second monitoring module 404 determines the first control card 300 has malfunctioned, and sends a message to the line cards 100. When the odd-numbered line cards 100 receive the message, the odd-numbered line cards 100 close the primary connections, and start the redundant connections. Meanwhile, the second control card 400 automatically replaces the first control card 300, and informs the network system to close the uplink ports 301 of the first control card 300. Similarly, if the first monitoring module 304 does not receive “hello” message from the second monitoring module 404 over the advance time period, the first control card 300 automatically replaces the second control card 400, and the uplink ports 401 of the second control card 400 are closed.

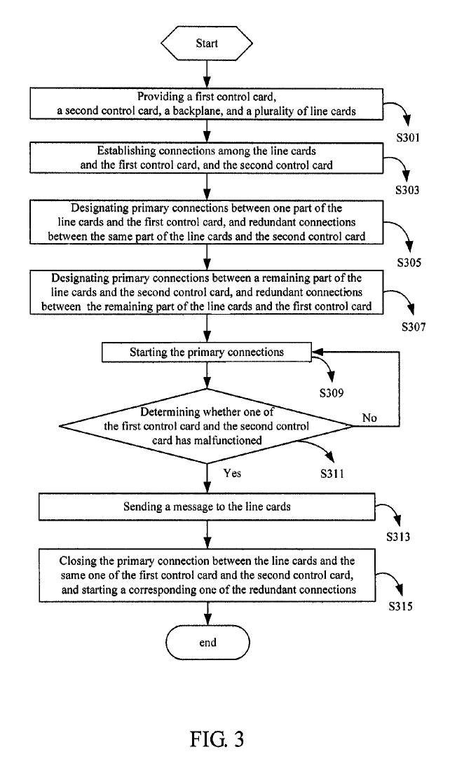

FIG. 3 is a flowchart of an operation method of the network system. In step S301, a first control card 300, a second control card 400, a backplane 200 and a plurality of line cards 100 are provided. In step 303, the backplane 200 establishes connections among the line cards 100 and the first control card 300, and the second control card 400. In step 305, the connections between the first control card 300 and one part of the line cards 100 are designated as primary connections, and the connections between the second control card 400 and the same part of the line cards 100 are designated as redundant connections. In step 307, the connections between the second control card 400 and a remaining part of the line cards 100 are designated as primary connections, and the connections between the first control card 300 and the remaining part of the line cards 100 are designated as redundant connections. In the exemplary embodiment, the line cards 100 are consecutively labeled as a first line card, a second line card, . . . , and a nth line card. Connections between the first control card 300 and odd-numbered line cards 100 are designated as primary connections, and connections between the odd-numbered line cards 100 and the second control card 400 are designated as redundant connections. Connections between the second control card 300 and even-numbered line cards 100 are designated as primary connections, and connections between the even-numbered line cards 100 and the first control card 300 are designated as redundant connections. Note that the primary and redundant connection settings can be reversed. In step 309, the primary connections are started.

In step 311, a first monitoring module 304 of the first control card 300 and a second monitoring module 404 of the second control card 300 cooperatively determine whether one of the first control card 300 and the second control card 400 has malfunctioned. If messages can be successfully delivered between the first monitoring module 304 and the second monitoring module 404, the network system is maintained in the primary connection (in step 309). In step 313, if one of the first control card 300 and the second control card 400 has malfunctioned, for example, the first control card 300 has malfunctioned, the second control card 400 sends a message to the line cards 100. In step 315, after the line cards 100 receive the message, the primary connections between the first control card 300 and the odd-numbered line cards 100 are closed, and the redundant connections between the second control card 400 and the odd-numbered line cards 100 are started. That is, the second control card 400 replaces the first control card 300, and the uplink ports 301 of the first control card 300 are closed.

Alternatively, if the second control card 400 has malfunctioned, in step 313 again, the first control card 300 sends a message to the line cards 100. In step 315, after the line cards 100 receive the message, the primary connections between the second control card 400 and the even-numbered line cards 100 are closed, and the redundant connections between the first control card 300 and the even-numbered line cards 100 are started. That is, the first control card 300 replaces the second control card 400, and uplink ports 401 of the second control card 400 are closed.

Because the uplink ports 301, 401 and the switch engines 303, 403 are effectively employed, the data packets can be quickly processed and transmitted in the network system.

Note that the number of line cards in each group is not required to be equal. In an alternative embodiment, the line cards 100 are categorized into primary line cards 100 and secondary line cards 100 at will. The connections between the primary line cards 100 and the first control card 300 are designated as primary connections, and the connections between the primary line cards 100 and the second control card 400 are designated as redundant connections. Meanwhile, the connections between the secondary line cards 100 and the second control card 400 are designated as primary connections, and the connections between the secondary line cards 100 and the first control card 400 are designated as redundant connections.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A network system, comprising:
a client device;
a central office; and
a network device connected to the client device and the central office, the network device comprising:
a first control card;
a second control card; and
a plurality of line cards connected to the first control card, the second control card, and the client device;
wherein connections between the first control card and one part of the line cards is designated as primary connections, and connections between the second control card and said one part of the line cards is designated as redundant connections; meanwhile, connections between the second control card and a remaining part of the line cards is designated as primary connections, and connection between the first control card and said remaining part of the line cards is designated as redundant connections.

2. The network system as claimed in claim 1, further comprising a backplane for connecting the line cards to the first control card and the second control card.

3. The network system as claimed in claim 2, wherein the first control card comprises at least one uplink port and at least one processing module, and the second control card comprises at least one uplink port and at least one processing module; and wherein the at least one uplink port receives data packets from the central office, and sends the data packets to the at least one processing module.

4. The network system as claimed in claim 3, wherein the first control card further comprises a switch engine, and the second control card further comprises a switch engine; and wherein the at least one processing module processes the data packets, and transmits the processed data packets to the switch engine.

5. The network system as claimed in claim 4, wherein the switch engine determines destination of the processed data packets, and transmits the processed data packets according to the destination.

6. The network system as claimed in claim 2, wherein each of the line cards comprises a downlink port connected to the backplane.

7. The network system as claimed in claim 6, wherein the downlink port receives data packets from the client device, the first control card, and the second control card.

8. The network system as claimed in claim 1, further comprising an asymmetrical digital subscriber loop transceiver unit-remote terminal connecting the client device and the line cards.

9. The network system as claimed in claim 1, further comprising a network for connecting the central office to the first control card and the second control card.

10. The network system as claimed in claim 1, wherein the first control card comprises a first monitoring module, and the second control card comprises a second monitoring module, the first monitoring module and the second monitoring module sending a message to each other to determine whether one of the first control card and the second control card has malfunctioned.

11. An operation method of a network system, the operation method comprising:
providing a first control card, a second control card, a backplane, and a plurality of line cards;
establishing connections among the line cards and the first control card and the second control card;
designating primary connections between the first control card and one part of the line cards, and redundant connections between the second control card and said one part of the line cards;
designating primary connections between the second control card and a remaining part of the line cards, and redundant connections between the first control card and said remaining part of the line cards; and
starting the primary connections.

12. The operation method as claimed in claim 11, further comprising a step of determining whether one of the first control card and the second control card has malfunctioned after starting the primary connections.

13. The operation method as claimed in claim 12, further comprising a step of informing the line cards if one of the first control card and the second control card has malfunctioned.

14. The operation method as claimed in claim 12, further comprising steps of closing the primary connection between the line cards and said one of the first control card and the second control card, and starting a corresponding one of the redundant connections if one of the first control card and the second control card has malfunctioned.

15. The operation method as claimed in claim 11, wherein the first control card comprises at least one uplink port and at least one processing module, and the second control card comprises at least one uplink port and at least one processing module; and wherein the at least one uplink port receives data packets and sends the data packets to the at least one processing module.

16. The operation method as claimed in claim 15, wherein the first control card further comprises a switch engine, and the second control card further comprises a switch engine; and wherein the at least one processing module processes the data packets, and transmits the processed data packets to the switch engine.

17. The operation method as claimed in claim 15, wherein the switch engine determines destination of the processed data packets, and transmits the processed data packets according to the destination.

18. The operation method as claimed in claim 11, wherein each of the line cards comprises a downlink port connected to the backplane, the downlink port for receiving data packets from the first control card and the second control card.

19. A method for operation of a network system, comprising the steps of:
installing a first control card and a second control card functionally same as said first control card in a network device;
establishing communication from said network device to at least one client device and at least one central office (CO), respectively;
designating primary connection and redundant connection for each of said first control card and said second control card;
activating primary connections of said first and second control cards simultaneously to transmit data packets together between said network device and said at least one client device, and between said network device and said at least one CO; and
activating said redundant connection of one of said first and second control card when the other of said first and second control card is verified as being malfunctioned.

20. The method as claimed in claim 19, wherein a plurality of line cards are installable in said network device to be communicable with said first and second control cards and to be designated to said first and second control cards, respectively, for said primary connections and said redundant connections of said first and second control cards.
